(19) United States
(12) Patent Application Publication
(10) Pub. No.: US 2025/0033023 A1
(43) Pub. Date: Jan. 30, 2025

(54) MATERIALS, SYSTEMS, AND PROCESSES FOR PRODUCTION OF HIGH PURITY OXYGEN

(71) Applicants: SUSTEON INC., Cary, NC (US); GEORGIA TECH RESEARCH CORPORATION, Atlanta, GA (US)

(72) Inventors: MANJESHWAR GANESHA KAMATH, Marietta, GA (US); RYAN P. LIVELY, Atlanta, GA (US); JIAN ZHENG, Chapel Hill, NC (US); SHAOJUN JAMES ZHOU, Cary, NC (US)

(21) Appl. No.: 18/716,787

(22) PCT Filed: Dec. 6, 2022
(86) PCT No.: PCT/US2022/080965

§ 371 Date: Jun. 5, 2024

Related U.S. Application Data
(60) Provisional application No. 63/286,541, filed on Dec. 6, 2021.

(51) Int. Cl. B01J 20/20; B01D 53/047; B01J 20/18; B01J 20/26; B01J 20/28; C01B 13/02

(52) U.S. Cl. CPC B01J 20/20; B01D 53/047; B01J 20/186; B01J 20/262; B01J 20/28023; B01J 20/28028; C01B 13/0266; C01B 13/027; B01D 2253/102; B01D 2253/108; B01D 2253/116; B01D 2253/202; B01D 2253/25; B01D 2253/304; B01D 2256/12; B01D 2257/102; B01D 2257/11

(57) ABSTRACT

A structured adsorbent assembly is described, which is usefully employed for pressure swing adsorption (PSA) processing of ambient air to generate high purity oxygen. The structured adsorbent assembly in various implementations may include cellulosic carbon molecular sieve fibers formed by spinning of precursor cellulose followed by pyrolysis of the spun fibers, as an argon-selective adsorbent, or AgX zeolite contained on and/or in polymeric fibers, as an argon-selective adsorbent, and such argon-selective adsorbents may be in combination with nitrogen-selective adsorbent such as LiX zeolite contained on and/or in polymeric fibers. The structured adsorbent assembly may be employed in PSA systems and processes to achieve highly efficient and economic generation of high purity oxygen for applications such as distributed gasification power generation.

### CROSS-REFERENCE TO RELATED APPLICATION

The benefit under 35 USC § 119 of U.S. Provisional Patent Application 63/286,541 filed Dec. 6, 2021 in the names of Manjeshwar G. Kamath, Ryan P. Lively, Jian Zheng, and Shaojun James Zhou for “Materials, Systems, and Processes for Production of High Purity Oxygen” is hereby claimed, and the disclosure thereof is hereby incorporated herein by reference in its entirety, for all purposes.

### BACKGROUND

### Field of the Disclosure

The present disclosure relates to adsorbent materials, adsorption systems, and adsorption processes for production of high purity oxygen.

### Description of the Related Art

High purity oxygen is widely used in industry and commerce, for diverse applications including for example semiconductor and optical fiber manufacturing, inhalation therapy, operation of analytical instruments, operation of gas-cooled nuclear reactors, steelmaking, wastewater treatment, chemicals manufacture, and glass and ceramic production. An increasingly important application holding potential for beneficial use of high purity oxygen is power generation.

Cryogenic air separation is a standard commercial technology for producing high purity oxygen at concentrations of 99+% O₂, but cryogenic air separation systems are highly capital-intensive and require large parasitic power loads. As an example, a cryogenic air separation system in a conventional integrated combined cycle (IGCC) power plant typically represents more than 25% of the overall capital cost, more than 30% of overall operating expense, and approximately 40% of the auxiliary parasitic load of the power plant. In addition, cryogenic air separation systems do not scale down cost-effectively below production levels of 100-200 tons of oxygen/day.

Pressure swing adsorption (PSA) and vacuum-pressure swing adsorption (VPSA) systems that are based on nitrogen-selective adsorbents such as LiX zeolite adsorbents are commercially available for generating oxygen and are cost-effective at smaller scales, e.g., oxygen production of 1-100 tons of oxygen/day. However, since PSA and VPSA systems process ambient air, containing argon and other minor component gases that cannot be adsorptively removed by LiX zeolites or other adsorbents conventionally used in such systems, oxygen purity is typically on the order of 90-92% O₂.

In applications such as 1-5 MW distributed gasification power generation plants, oxygen generation systems are needed that supply oxygen at a rate of 10-50 tons/day and at purity levels >95% O₂. Flexible and small-scale, modular gasification systems are currently of substantial and increasing importance for converting diverse types of United States domestic coal into clean fuels with greatly reduced greenhouse gas emissions. In these applications, neither currently available PSA/VPSA technology nor state-of-the-art cryogenic air separation can be utilized economically.

Accordingly, there is a clear and compelling need in the art for small-scale, high-efficiency technology for generating oxygen at purity levels greater than >95% O₂ and at rates of up to 50 tons oxygen/day.

### SUMMARY

The present disclosure relates to adsorbent materials, adsorption systems, and adsorption processes for production of high purity oxygen.

In one aspect, the disclosure relates to a structured adsorbent assembly, comprising an array of generally parallelly aligned cellulose pyrolyzate carbon fibers that are sorptively selective for argon when contacted with an oxygen and argon gas mixture, wherein the generally parallelly aligned cellulose pyrolyzate carbon fibers are sized and arranged to provide interstitial gas flow passages between adjacent generally parallelly aligned fibers of the array for flow of gas therethrough.

In another aspect, the disclosure relates to a structured adsorbent assembly, comprising: (i) LiX zeolite contained on and/or in first polymeric fibers; and (ii) one selected from the group consisting of (a) AgX zeolite contained on and/or in second polymeric fibers, and (b) cellulosic carbon molecular sieve fibers.

A further aspect of the disclosure relates to a structured adsorbent assembly, comprising: (i) a nitrogen-selective adsorbent; and (ii) one selected from the group consisting of (a) AgX zeolite contained on and/or in polymeric fibers, and (b) cellulosic carbon molecular sieve fibers.

In a further aspect, the disclosure relates to a pressure swing adsorption (PSA) system comprising at least one adsorber vessel containing the structured adsorbent assembly as variously described herein.

A still further aspect of the disclosure relates to a pressure swing adsorption (PSA) process for production of high purity oxygen, the process comprising: contacting gas containing oxygen, nitrogen, and argon with a first adsorbent selective for nitrogen to at least partially adsorb nitrogen from the gas to yield nitrogen-depleted gas; contacting the nitrogen-depleted gas with a second adsorbent selective for argon to at least partially adsorb argon from the gas to yield high purity oxygen; and recovering the high purity oxygen, wherein the first adsorbent and the second adsorbent when loaded to a predetermined extent with sorbate are regenerated by pressure swing desorption of sorbate therefrom, to renew the first adsorbent and the second adsorbent for renewed contacting in the PSA process, wherein the first adsorbent and the second adsorbent are comprised in a structured adsorbent assembly as variously described herein.

Other objects, features, advantages, and embodiments of the disclosure will be more fully apparent from the ensuing description and appended claims.

### BRIEF DESCRIPTION OF THE DRAWINGS

FIG. 1 depicts an illustrative fiber spinning process system that may be used to produce fibers for fiber modules of the present disclosure.

FIG. 2 it is a schematic representation of an LiX-loaded MATRIMID® polyimide fiber adsorbent, according to one embodiment of the present disclosure.

FIG. 3 shows scanning electron microscopy (SEM) micrographs of various fiber adsorbents, including: (A1) a low magnification image of a LiX-MATRIMID® polyimide fiber cross-section; (A2) a fiber adsorbent microstructure, exhibiting good dispersion of LiX zeolite particles and typical sieve in a cage morphology; (B1) a low magnification image of an entire AgX-MATRIMID® polyimide fiber cross-section; (B2) a fiber adsorbent microstructure, exhibiting good dispersion of AgX rod-like particles; and (C) a low magnification image of a porous cellulosic carbon molecular sieve (CMS) fiber cross-section.

FIG. 4 shows thermogravimetric analysis (TGA) mass profiles for sorbent powder (black) and sorbent-MATRIMID® polyimide fibers (red) in an air atmosphere, wherein (A) shows results for LiX, and (B) shows results for AgX, with values normalized to sample weights recorded after a 60-minute soak at 200° C. to remove most of the adsorbed water.

FIG. 5 shows isotherms, including: (A) N₂ and O₂ adsorption isotherms for LiX-MATRIMID® polyimide fiber adsorbents; (B) N₂, O₂, and Ar adsorption isotherms for AgX; and (C) N₂, O₂, and Ar adsorption isotherms for CMS.

FIG. 6 shows images of: (A) LiX-MATRIMID® polyimide fibers; (B) AgX-MATRIMID® polyimide fibers; (C1) cellulose fibers; and (C2) CMS fibers after pyrolysis, which the fibers are kept parallel with minimum entanglement.

FIG. 7 shows fiber modules, including: (A1) LiX-MATRIMID® polyimide fibers threaded into a tube to which the illustrated fittings are attached; (A2) the corresponding assembled LiX-MATRIMID® polyimide fibers fitted module; (B) an AgX-MATRIMID® polyimide fibers fitted module; and (C) a cellulose CMS fibers fitted module.

FIG. 8 shows images of subassemblies of a PSA system in accordance with an illustrative embodiment of the present disclosure, including: (A) a thermocouple; (B) heating tape wrapped around the module and activated at elevated temperatures (380° C.) under flowing inert gas (He); and (C) two modules as installed inside the PSA unit.

FIG. 9 is a schematic representation of a two-bed PSA system for high purity O₂ production according to one embodiment of the present disclosure, including a multi-layer LiX-CMS fiber structured adsorbent module for adsorption of nitrogen and argon, in each of the two adsorber vessels.

### DETAILED DESCRIPTION

The present disclosure relates to materials, systems, and processes for generating high purity oxygen.

The disclosure, as variously set out herein in respect of features, aspects and embodiments thereof, may in particular implementations be constituted as comprising, consisting, or consisting essentially of, some or all of such features, aspects and embodiments, as well as elements and components thereof being aggregated to constitute various further implementations of the disclosure. The disclosure is set out herein in various embodiments, and with reference to various features and aspects of the disclosure. The disclosure contemplates such features, aspects and embodiments in various permutations and combinations, as being within the scope of the invention. The disclosure may therefore be specified as comprising, consisting or consisting essentially of, any of such combinations and permutations of these specific features, aspects and embodiments, or a selected one or ones thereof.

As used herein and in the appended claims, the singular forms “a”, “and”, and “the” include plural referents unless the context clearly dictates otherwise.

As used herein, the term “high purity oxygen” refers to oxygen-containing gas of at least 95% oxygen purity.

The present disclosure relates in one aspect to a structured adsorbent assembly, comprising an array of generally parallelly aligned cellulose pyrolyzate carbon fibers that are sorptively selective for argon when contacted with an oxygen and argon gas mixture, wherein the generally parallelly aligned cellulose pyrolyzate carbon fibers are sized and arranged to provide interstitial gas flow passages between adjacent generally parallelly aligned fibers of the array for flow of gas therethrough.

The structured adsorbent assembly in various embodiments may be constituted, wherein the cellulose pyrolyzate carbon fibers are spun fibers and the cellulose comprises microcrystalline cellulose. The cellulose pyrolyzate carbon fibers may have any suitable length and diameter characteristics, and may for example have a diameter in a range of from 200 μm to 800 μm, although the disclosure is not limited thereto.

In various embodiments, the structured adsorbent assembly may be constituted, wherein the array of generally parallelly aligned cellulose pyrolyzate carbon fibers constitutes a first portion of the structured adsorbent module, and the structured adsorbent assembly includes at least a second adsorbent portion comprising a nitrogen-selective adsorbent, e.g., LiX zeolite, such as in a form in which the zeolite is contained on and/or in polymeric fibers. The polymeric fibers may be of any suitable material, and may for example comprise polyimide fibers, although the disclosure is not limited thereto. The polymeric fibers may have any suitable length and diameter characteristics, and may for example have a diameter in a range of from 200 μm to 800 μm, although the disclosure is not limited thereto.

The polymeric fibers in the structured adsorbent assembly may be generally parallelly aligned with one another in an array thereof, wherein the generally parallelly aligned polymeric fibers are sized and arranged to provide interstitial gas flow passages between adjacent generally parallelly aligned polymeric fibers of the array for flow of gas therethrough.

In specific embodiments, the interstitial gas flow passages in the second adsorbent portion of the structured adsorbent assembly may be generally aligned with the interstitial gas flow passages in the first adsorbent portion of the structured adsorbent assembly, so as to accommodate serial gas flow through the first and second adsorbent portions of the structured adsorbent assembly.

In another aspect, the disclosure relates to a structured adsorbent assembly, comprising: (i) LiX zeolite contained on and/or in first polymeric fibers; and (ii) one selected from the group consisting of (a) AgX zeolite contained on and/or in second polymeric fibers, and (b) cellulosic carbon molecular sieve fibers. Such structured adsorbent assembly may be constituted with the first polymeric fibers and second polymeric fibers comprising polyimide fibers, although the disclosure is not limited thereto.

In a further aspect, the disclosure relates to a structured adsorbent assembly, comprising: (i) a nitrogen-selective adsorbent; and (ii) one selected from the group consisting of (a) AgX zeolite contained on and/or in polymeric fibers, and (b) cellulosic carbon molecular sieve fibers. The polymeric fibers may comprise any suitable material, e.g., polyimide fibers. The structured adsorbent assembly may be constituted wherein fibers therein are comprised in fiber bundles through which gas containing components sorbable by adsorbents of the structured adsorbent assembly are flowable.

A further aspect of the present disclosure relates to a pressure swing adsorption (PSA) system comprising at least one adsorber vessel containing the structured adsorbent assembly of the present disclosure, as variously described herein. The PSA system may comprise at least two adsorber vessels each containing the structured adsorbent assembly, or more generally may comprise multiple adsorber vessels each containing the structured adsorbent assembly, wherein the multiple adsorber vessels are constructed and arranged so that each of the multiple adsorber vessels cyclically, alternatingly, and repetitively undergoes a sequence of onstream high purity oxygen production operation and an offstream regeneration operation, in operation of the PSA system. The PSA system may be constructed and arranged for vacuum PSA operation, or other modes of PSA operation.

The disclosure relates in a further aspect thereof to a pressure swing adsorption (PSA) process for production of high purity oxygen, the process comprising: contacting gas containing oxygen, nitrogen, and argon with a first adsorbent selective for nitrogen to at least partially adsorb nitrogen from the gas to yield nitrogen-depleted gas; contacting the nitrogen-depleted gas with a second adsorbent selective for argon to at least partially adsorb argon from the gas to yield high purity oxygen; and recovering the high purity oxygen, wherein the first adsorbent and the second adsorbent when loaded to a predetermined extent with sorbate are regenerated by pressure swing desorption of sorbate therefrom, to renew the first adsorbent and the second adsorbent for renewed contacting in the PSA process, wherein the first adsorbent and the second adsorbent are comprised in a structured adsorbent assembly of the present disclosure, as variously described herein, in any suitable embodiments and/or modifications thereof.

The present disclosure in various aspects and embodiments provides a highly efficient low energy consuming high purity O₂ generation system, fibrous adsorbent materials useful for high purity O₂ generation, and multi-layer fiber module rapid PSA processes. As described more fully hereinafter, the structured adsorbents of the present disclosure may utilize LiX (lithium ion-exchanged X type) zeolite adsorbent or other suitable N₂-selective adsorbent as a base layer, and achieve high purity O₂ generation with exceptionally low pressure drop and excellent N₂-adsorptive capability, enabling PSA O₂ generation systems utilizing such structured adsorbents to achieve substantially improved working capacity, thereby realizing substantial reductions, e.g., on the order of 50% or more, of bed-size-factor (BSF), as compared to conventional PSA systems using standard bead form LiX in packed beds.

The structured adsorbents of the present disclosure, in addition to the base layer adsorbent, such as LiX zeolite, utilize argon-selective fiber adsorbent in a second layer of the structured adsorbent. The argon-selective fiber adsorbent may comprise adsorbent such as carbon molecular sieve (CMS) or silver-containing X type zeolite (AgX). The argon-selective fiber adsorbent layer may be associated with the base layer in any suitable manner, e.g., as a top layer of a multi-layer structured adsorbent overlying the base layer thereof. The argon-selective fiber adsorbent effects removal of argon from the feed gas, so that high purity O₂ generation is reliably achieved.

The structured adsorbents of the present disclosure may be formed with a suitable base adsorbent such as LiX zeolite, in the form of a powder, which is incorporated in a dope formulation with suitable solvents and binders. The base adsorbent in the dope formulation may have any suitable selected particle size and particle size distribution characteristics. The dope formulation is then employed to produce structured adsorbent articles such as monolith, 3D printed shapes, or hollow and solid fibers with active adsorbent. By appropriate selection of binder, the N₂ adsorption capacity of the base adsorbent can be maintained at a same or similar level as the original base adsorbent material without any significant loss of adsorption capability. Thus, for example, a base adsorbent LiX zeolite layer can be produced with a same or similar nitrogen adsorption capacity as virgin LiX crystal that is introduced to the dope formulation.

In order for LiX base adsorbent to adsorb nitrogen, it needs to be activated at temperature above 350° C. to remove residual moisture. For this purpose, structured adsorbent fibers are employed that accommodate the high temperature activation process while maintaining high nitrogen capacity of the base adsorbent. Suitable materials for such structured adsorbent fibers include, for example, polyimides, polyetherimides, polytetrafluoroethylenes, and polycyanurates, although the disclosure is not limited thereto. Particularly preferred structured adsorbent fiber materials include polyimides, such as MATRIMID® polyimide (Huntsman Corporation, The Woodlands, Texas, USA). It is beneficial for the activated fiber adsorbents to contain minimal amounts of non-adsorptive inert components deriving from the binder, in order to maximize adsorption capacity.

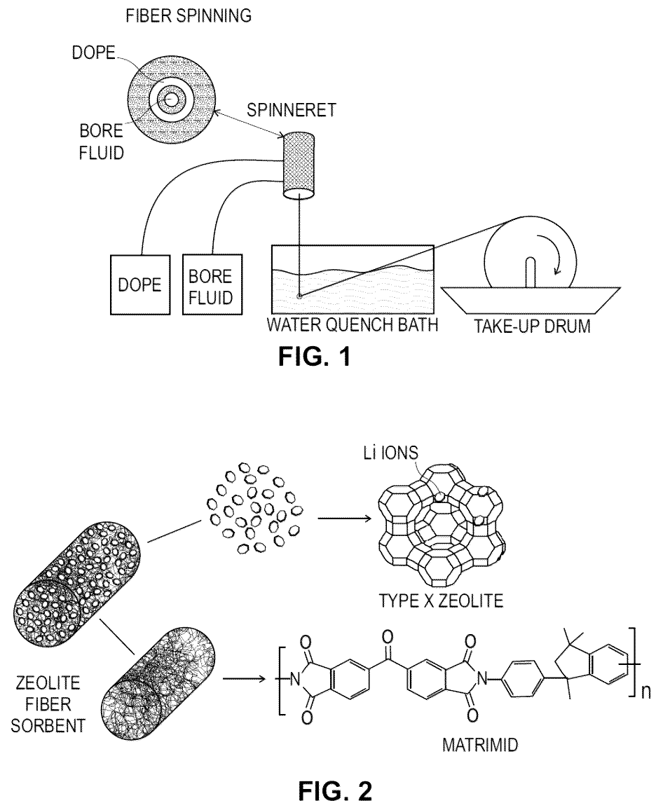

Fiber adsorbents for the structured adsorbent may be formed in any suitable manner, and may for example be spun from the dope formulation based on phase inversion techniques such as dry-jet wet-quench spinning using a fiber spinning line of the type schematically shown in FIG. 1.

For this purpose, the synthesis of the fiber adsorbent, such as a zeolite-polyimide fiber adsorbent by way of example, may involve determining the composition of the primary dope solution without adsorbent particles, based on a predetermined temary phase diagram. The polymer-zeolite dope then may be co-extruded through a co-annular spinneret (without bore fluid for non-hollow fiber spinning), with the nascent fibers passing through an “air gap” above a quench bath, where any volatile solvents or non-solvent components evaporate, thereby increasing the polymer concentration in the dope. The fiber then descends into a non-solvent quench bath, which may for example be a water bath as shown in FIG. 1.

Deionized (DI) water is preferably used for phase inversion to avoid cation exchange of zeolite with sodium ions that may otherwise be present in water from commercial or industrial sources. Here, the non-solvent diffuses into the polymer dope while at same time the solvent diffuses out. Depending on the phase separation mechanism that is occurring, polymer-lean and polymer-rich phases will either rapidly de-mix—causing the polymer-lean phase to be washed out of the fiber while the polymer-rich forms the solid support—or will undergo nucleation and growth.

Finally, a collection system, such as a pulley drum system (take-up drum), guides and collects the fibers at a predetermined take-up rate. The ratio of the take-up rate to the extrusion rate is known as the draw ratio. Control over the draw ratio allows for control over the fiber outer diameter.

As an illustrative example, FIG. 2 is a schematic representation of an LiX-loaded MATRIMID® polyimide fiber adsorbent, according to one embodiment of the present disclosure. For the preparation of such fiber adsorbent, LiX zeolite powder was obtained from commercial sources with the initial N₂ and O₂ isotherms evaluated using a Micromeritics ASAP 2020 system. This LiX zeolite powder exhibited a high N₂ capacity of 1.3 mmol N₂/g zeolite at 1 atm absolute pressure, as compared to only 0.2 mmol O₂/g zeolite for O₂ adsorption, with a corresponding N₂/O₂ selectivity of 6.5. This LiX powder was utilized in fiber spinning to fabricate fiber adsorbents with LiX zeolite dispersed uniformly in the porous MATRIMID® polyimide substrate, as depicted in FIG. 2.

In the fiber spinning process for forming such illustrative LiX-loaded polyimide fiber adsorbent, a polymeric dope was formulated containing the LiX powder, polyimide, N-methyl-pyrrolidone (NMP), deionized water, and LiNO₃ additive. The polymeric dope was extruded into a deionized water quench bath. Fiber spinning conditions were controlled to allow continuous production of fibers with approximately 500 μm diameter. The spun LiX fibers then were washed in deionized water for three days, changing the bath water every 24 hours to remove any remaining NMP, and then the water in the fiber was exchanged three times with methanol (each ˜30 minutes in duration, exchanging with new methanol), followed by exchange three times with hexane (30 minutes in duration, exchanging with new hexanes each time). Deionized water and anhydrous NMP were used in the dope and extrusion process to reduce the risk of ion exchange with any impurities in the water.

Argon-selective fiber adsorbent, e.g., AgX zeolite fiber adsorbent, may also be prepared using corresponding fiber spinning techniques. The combination of a first layer nitrogen-selective adsorbent such as LiX, with a second layer argon-selective adsorbent such as AgX, when used in a PSA system enables such system to remove a majority of N₂ and Ar from an ambient air feed to produce >95% purity O₂. For AgX fiber spinning, a polymer dope composition may be employed such as the composition specified in Table 1 below. Table 1 also includes for comparison an illustrative polymer dope composition for forming LiX fiber.

TABLE 1
Polymer Dope Composition Used For Polyimide
Fiber Sorbent Manufacture

| Component | Mass % | |
|---|---|---|
| Sorbent | LiX | AgX |
| Sorbent mass* | 28 | 28 |
| NMP | 60 | 60 |
| H₂O | 0.5 | 0.5 |
| Matrimid ® polyimide* | 9.3 | 9.3 |
| LiNO₃* | 2.2 | 0 |
| PVP* | 0 | 2.2 |

* Dried at 80 C. for >12 h at 80° C. in vacuum

The present disclosure also contemplates a novel cellulose-based carbon molecular sieve (CMS) fiber sorbent. CMS sorbents are known to separate gases based on differences in mass transfer rates through constricted pores. Conventional CMS adsorbents are well suited for the separation of oxygen and argon, as the mass transfer rate of argon is approximately 60 times slower than that of oxygen. However, PSA systems based on mass transfer rate (also known as kinetic) separation involve complex cycle designs and require a second stage PSA unit in the PSA system in order to produce >95% oxygen. The CMS fiber adsorbent of the present disclosure obviates such deficiencies of the prior art, and exhibits a high argon equilibrium selectivity, enabling such CMS adsorbent to be used in existing one-stage PSA systems for carrying out rapid PSA. The CMS adsorbent thus may be incorporated in a multi-layer adsorbent, wherein respective layers are selective for nitrogen (base layer) and argon (layer formed on the base layer).

The CMS fiber adsorbent of the present disclosure may be prepared in any suitable manner providing a fiber adsorbent of the desired argon selectivity, argon capacity, and compatibility characteristics. In various embodiments, the CMS fiber adsorbent is prepared using a cellulose precursor fiber that is processed by pyrolysis at suitable temperature. By way of example, and in one illustrative implementation, the CMS fiber adsorbent was synthesized using a 600 g dope formulation that was prepared by heating a mixture of micro-crystalline cellulose powder, LiCl, and NMP in a round bottom flask under inert atmosphere for 4 hours at 160° C. Cellulose fibers (as precursors for the CMS fiber adsorbent) were produced by dry jet spinning of the dope formulation into quench water.

An exemplary cellulose dope formulation is identified in Table 2, and spinning conditions are identified in Table 3, as compared to LiX and AgX zeolite fibers. As-spun cellulose fibers prepared from such cellulose dope formulation utilizing the spinning conditions identified in Table 3 were solvent exchanged in water, methanol, and hexane, in the manner described hereinabove for LiX and AgX adsorbent fibers. After solvent exchange, the cellulose fibers were treated with 10% glycerol in water and then dried in the ambient atmosphere to minimize fiber curling/coiling during the subsequent pyrolysis. CMS fibers were produced from the dried cellulose fibers by controlled pyrolysis of the cellulose fibers in an inert atmosphere at 450° C. or higher temperature.

TABLE 2
Polymer Dope Formulation Used
For Cellulose Fiber Manufacture

| Component | Mass % |
|---|---|
| Cellulose | 10 |
| LiCl | 10 |
| NMP | 80 |

TABLE 3
Spinning Conditions For Polyimide Fiber Adsorbent
and Cellulose Fiber Manufacture

| | LiX | AgX | Cellulose |
|---|---|---|---|
| Fiber | Fiber | Fiber | Fiber |
| Spinning temp ° C. | 50 | 50 | 25 |
| Air gap cm | 3 | 3 | 1 |
| Quench DI water temp ° C. | 50 | 50 | 25 |
| Dope flow rate ml/h | 400 | 400 | 720 |
| Take-up speed m/min | 16 | 16 | 12 |

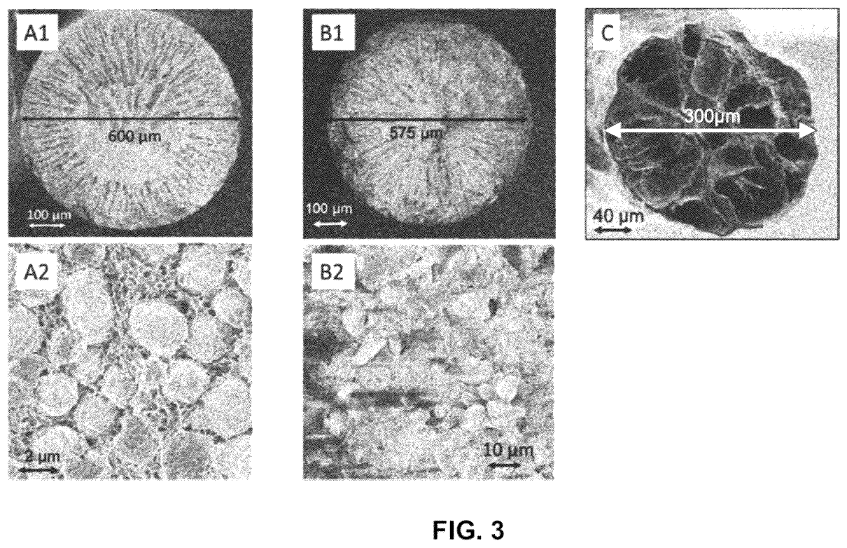

SEM (Scanning Electron Microscopy) testing was carried out on the adsorbent fibers to determine the fiber sorbent micro-structure and the loading of the adsorbent particles in the polyimide fibers. In order to achieve high performance, it is necessary for fiber adsorbents to have a good dispersion of adsorbent particles throughout the porous polymer matrix and skin of the fiber. SEM is usefully employed to observe the polymeric fiber structure and micro-structure by high magnification imaging. FIG. 3 in images A1, B1, and C show LiX-Matrimid® polyimide fiber, AgX-Matrimid® polyimide fiber, and cellulosic CMS fiber, respectively, under low magnification. The fibers are generally cylindrical, with many macro voids in the substructure. These macro voids enable gas transport through the fiber backbone, with rapid mass transfer from the fiber surfaces to the adsorbent particles dispersed throughout the polymeric matrix of the fibers.

FIG. 3 in images A2 and B2 shows the microstructure of the fiber adsorbent, with the zeolite particles dispersed throughout the polymer matrix. The LiX particles in image A2 show a sieve-in-a-cage-like morphology, where a small void surrounds the zeolite particle. This morphology is desirable, as being free of dense polymer surrounding the zeolite particles, which may reduce the mass transfer rate. Similarly, image B2 shows AgX rod-like particles embedded in the polyimide polymer matrix. Cellulosic CMS (FIG. 3 in image C) also shows macro and microporous structure. The macropores are desired so that the bulk gas phase flowing through the adsorbent bed rapidly equalizes throughout the fiber.

Residual mass analysis was performed using TGA (Termogravimetric Analysis) on the above-described fiber products to determine the loading of the adsorbent within the fiber. In this analysis, the samples were decomposed in an air environment under a controlled temperature ramp. The amount of residual mass at the end of the decomposition allows for the determination of the adsorbent loading in the fiber, since zeolite material will not lose any mass during the polymer's decomposition except for removal of adsorbed water, which can be accounted for in the TGA calculation.

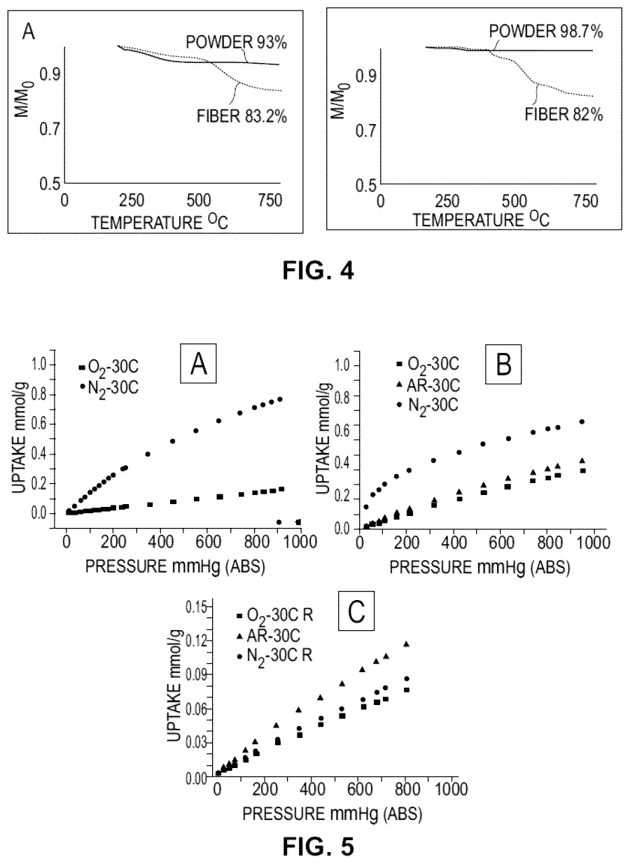

FIG. 4 shows the resulting thermogravimetric analysis (TGA) mass profiles (A: LiX, B: AgX) for the adsorbent powders (black) and adsorbent-Matrimid® polyimide fibers (red) in an air atmosphere. The mass profiles are normalized to the sample's mass after a 60-minute soak at 200° C. to remove all the pre-sorbed water from the polymer and the vast majority of the pre-sorbed water from the zeolite. Since the adsorbent zeolite is inorganic, taking the ratio of the mass remaining (residual mass) after a temperature ramp to 800° C., where all polyimide will be decomposed, allows for estimating the sorbent mass in the fiber sample. In both cases, the zeolite fiber's sorbent loading was approximately 85 wt %, similar to conventional beaded zeolite with approximately 10-15 wt % inorganic binders.

FIG. 5 shows isotherms, including: (A) N₂ and O₂ adsorption isotherms for LiX-Matrimid® polyimide fiber adsorbent; (B) N₂, O₂, and Ar adsorption isotherms for AgX adsorbent; and (C) N₂, O₂, and Ar adsorption isotherms for CMS adsorbent. FIG. 5 in graph A shows that the N₂/O₂ selectivity of LiX adsorbent is approximately 5, whereby it is suitable for O₂—N₂ separations as a first (base layer) adsorbent. FIG. 5 in graphs B and C show shows that the Ar/O₂ selectivity of CMS adsorbent is approximately 1.5 versus approximately 1.2 for AgX adsorbent (i.e., CMS adsorbent is 20% more selective for argon than AgX adsorbent). These results show that multilayer fiber adsorbents including a base layer fiber adsorbent of LiX polyimide fiber and a second layer (top layer) fiber adsorbent of AgX polyimide fiber or CMS fiber provide excellent nitrogen- and argon-adsorption characteristics for effective rapid single-stage PSA production of high purity oxygen.

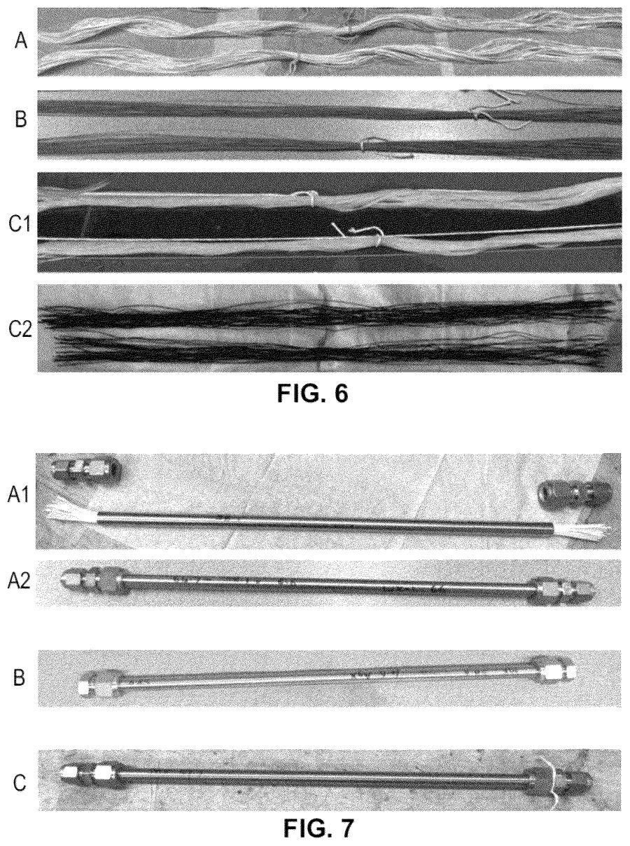

FIG. 6 shows images of adsorbent fiber rovings of: (A) LiX-Matrimid® polyimide fibers; (B) AgX-Matrimid® polyimide fibers; (C1) cellulose fibers; and (C2) CMS fibers after pyrolysis, in which the fibers are kept parallel with minimum entanglement. The adsorbent fibers shown in the FIG. 6 adsorbent fiber bundles are approximately 1 meter in length and 500-600 μm in diameter, except for the CMS adsorbent fibers, which shrank during pyrolysis to a length of approximately 0.65 meter and a diameter of approximately 300 μm. The LiX-Matrimid® polyimide fibers (A) are of cream color, and the AgX-Matrimid® polyimide fibers (B) are of grey color, with the color of the fibers being imparted by the adsorbent particles therein. The cellulose precursor fibers (C1) are light yellow in color, and turned black during pyrolysis to CMS (C2).

Utilizing the respective fibers, PSA modular beds were prepared by carefully threading each of the respective bundles of parallelly aligned fibers into a separate 0.775 cm inner diameter/0.953 cm outer diameter Swagelok® tube that was 30 cm in length. In each case, about 60-70 fibers were packed into the bed for fixed-bed experiments. Images of the fiber adsorbent beds are shown in FIG. 7, including: (A1) LiX-Matrimid® polyimide fibers threaded into a tube to which the illustrated fittings were subsequently attached; (A2) the corresponding assembled LiX-Matrimid® polyimide fibers module; (B) an assembled AgX-thus Matrimid® polyimide fibers module; and (C) an assembled cellulose CMS fibers module. Fibers were tightly packed in the respective tubes and laid parallel to the axial flow of gas in the dynamic adsorption experiments, and the fittings used to connect the fiber modules to the PSA system were tightly secured to the Swagelok® tubes of each of the fiber modules. The LiX and AgX modules were in-situ activated at 380° C. a day before starting PSA runs. Weight of the fibers contained in the module varied depending on the density, structure, and the number of the fibers threaded.

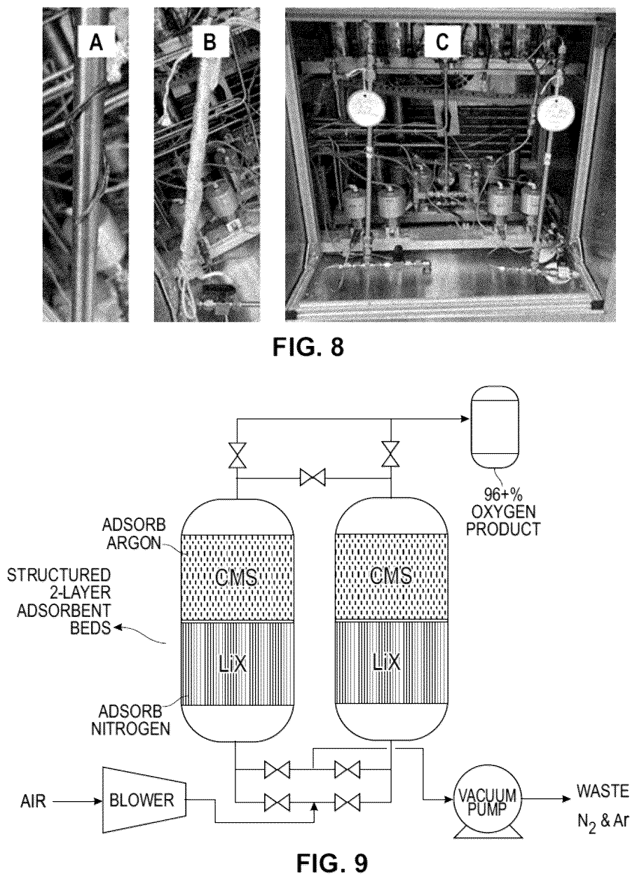

LiX and AgX fiber modules were in-situ activated inside the PSA system by passing under 100 standard cubic centimeters per minute (sccm) helium flow through the module to purge such modules of gases initially contained therein, and at elevated temperatures with a maximum external temperature of 380° C. The heat was applied using an electrical heating tape wrapped around the outside of the Swagelok tube, as shown in image (B) of FIG. 8, with a thermocouple installed at the bed's axial center on the outside of the module as shown in image (A) of FIG. 8. The activation temperature profile that was used for the activation is identified in Table 4 below. The activation temperature was ramped slowly and held at some temperatures near the removal of most of the adsorbed water to reduce the possibility of delamination of the sorbents in the fiber. Two fiber adsorbent modules were installed inside a PSA cabinet as shown in image (C) of FIG. 8 and the PSA system was operated to assess the performance of such fiber adsorbent modules.

TABLE 4
Activation Procedure for Matrimid ® Polyimide-Sorbent Fibers Before Fixed Bed Experiments

| Step | Procedure |
|---|---|
| 1 | Flow dry inert gas (N₂ or He) 100 sccm through the module bed throughout activation/cooling |
| 2 | Ramp 5° C./min from ambient temperature to 90° C. |
| 3 | Hold temperature at 90° C. for 120 minutes |
| 4 | Ramp 2° C./min from 90° C. to 150° C. |
| 5 | Hold temperature at 150° C. for 120 minutes |
| 6 | Ramp 5° C./min from 150° C. to 380° C. |
| 7 | Hold temperature at 380° C. for a minimum of 720 minutes |
| 8 | Allow the module to cool to room temperature |

Several series of PSA experiments were carried out as identified in Table 5 below. In all experiments, the PSA system was maintained at 25° C. and a back pressure control (BPC) was set at 1.5 bar. Within a series of experiments, the operating conditions that were varied were pressurization rate, feed rate, and feed time to minimize the pressure overshoot that would otherwise be experienced at higher pressurization rates. The pressure tolerance that controlled when the PSA system switches from the pressurization step to the feed step was optimized as a part of varying the pressurization rate. As seen in Table 5, the first two series data (Series 1 and 2) represent the base-layer LiX cases, in which feed dry air was processed in the PSA system with a single LiX bed, with a target of producing >90% O₂ purity. Series 3 through 8 represent the detailed studies on the Ar-removal second-layer, in which the feed gas was SG1 (simulated stage-1 product gas, with a composition of 90% O₂, 6% N₂ and 4% Ar), which was processed in the PSA system through an AgX fiber bed and/or CMS fiber bed with a target of producing >95% O₂ purity. In certain series (such as Series 5, 6 and 8) an additional LiX module was connected together with the AgX fiber module or CMS fiber module in order to adjust the 2-layer height/volume ratio, to achieve an adjusted range of N₂ removal.

First-layer cases (Series 1 and 2): In the Series 1 experiments, using dry air as feed and pressurizing gas, the highest purity obtained was only 59/a, mainly due to the lab system limitation in which the PSA system had >80% dead volume (volume occupied by the valves, piping, and fittings), which is to be contrasted with dead volumes that typically are only on the order of 20% in commercial PSA units. This dead volume affected the product composition, and in order to reduce or eliminate such system error, pure O₂ was used as the pressurizing gas in Series 2. The highest purity achieved in Series 2 was on the order of 93%. Bed size factor was maintained at a low level (between 360 and 434) and recovery at a high range of around 66%, confirming the technology advantage of high productivity of PSA conducted with the adsorbent fiber module vs. conventional beaded PSA systems.

Second-layer cases (Series 3 through 8): Using SG1 feed, PSA trials were conducted with AgX fiber adsorbent beds (Series 3) and produced O₂ of purity 91.5/a, and by using pure O₂ as a pressurizing gas, the produced O₂ purity increased to 96.9% (Series 6). Bed size factors remained low at around 111-153, with high recovery at around 67%. Even without using pure O₂ at pressurization, PSA trials with LiX+AgX beds (Series 4) produced O₂ of purity 93.5/a, and with LiX+CMS beds (Series 5) produced O₂ of purity 94.8%, bed size factor as low as 111 and recovery of 59%. Addition of more LiX appeared to favor CMS in producing higher O₂ purity, as comparing Series 4 with 5, and recognizing that the CMS fiber adsorbent bed mainly adsorbed Ar, while AgX fiber adsorbent has higher selectivity for N₂ (than Ar and O₂). Finally, with SG1 feed and pure O₂ pressurizing gas in Series 6 and 7, AgX fiber adsorbent or CMS fiber adsorbent beds could produce O₂ of purity >96%, with bed size factors less than 68, and recovery on the order of 67-81%. Series 8 further confirmed that if additional LiX is packed together with CMS bed, the product purity can reach as high as 98.4% O₂, with a bed size factor of 141, and recovery of approximately 58/a, meanwhile argon content of the product was decreased to levels as low as 1.4-1.6%.

TABLE 5
Series of PSA experiments.

| | | | | O₂ | Ar in the | Bed Size | O₂ |
|---|---|---|---|---|---|---|---|
| Series | Module | Feed | Pressurizing | Purity | product | Factor | Recovery |
| # | type | Gas | gas | Achieved | (%) | (lb/TPD) | (%) |
| 1 | LiX | Dry Air | Dry Air | 56.0% | — | 434 | 66.4 |
| 2 | LiX | Dry Air | Pure O₂ | 90.2% | — | 360 | 67.4 |
| 3 | AgX | *SG1 | SG1 | 91.5% | 3.4 | 153 | — |
| 4 | LiX + AgX | SG1 | SG1 | 93.5% | 3.3 | — | — |
| 5 | LiX + CMS | SG1 | SG1 | 94.8% | 3.6 | 111 | 59.0 |
| 6 | AgX | SG1 | Pure O₂ | 96.9% | 1.4 | 68 | 67.4 |
| 7 | CMS | SG1 | Pure O₂ | 96.4% | 1.4 | 25 | 80.9 |
| 8 | LiX + CMS | SG1 | Pure O₂ | 98.4% | 1.6 | 141 | 58.3 |

*SG1 composition: 90% O₂, 6% N₂, 4% Ar

Using CMS fiber adsorbent for argon selective adsorption is preferred, due to its confirmed higher Ar/O₂ selectivity and more importantly the lower material cost of CMS as compared to AgX zeolite fiber adsorbent. The combination of a second-layer low cost CMS fiber adsorbent for Ar adsorption, on top of a first-layer LiX zeolite fiber adsorbent for N₂ adsorption, with all layers in fiber structured forms, enables the production of >95% purity O₂ with an overall bed size factor around 450 lb/TPD O₂, which is substantially lower than the conventional LiX-bead PSA process with an overall bed size factor of approximately 600 lb/TPD O₂. Thus, the overall capital cost attributed to the adsorbent cost is reduced. At the same time, the high overall recovery and, most importantly, the low pressure drop of the fiber structured modules enable the PSA system of the present disclosure to be operated at maximum feed and product flow, even with the same arrangement of blower and vacuum pumps used in the conventional PSA system, thus generating more high purity oxygen more efficiently with lower unit operational cost. The overall unit cost of the multi-layer fiber structured PSA system of the present disclosure can be as low as $44/ton O₂, with >95% O₂ purity, as compared to the approximately $50/ton O₂ overall unit cost of conventional PSA systems that only produce approximately 90% O₂ purity product.

Although the disclosure herein is primarily directed to polyimide polymer fibers as the support matrix structure or carrier for the various adsorbents in the multilayer adsorbent, it will be recognized that any other polymeric or non-polymeric fibers may be employed that are compatible with the adsorbents and the operating conditions of the PSA system. Further, it will be recognized that although the multilayer fiber adsorbent is illustratively described herein as a 2-layer adsorbent including a nitrogen-adsorbing base layer and an argon-adsorbing top or second layer, the disclosure is not thus limited, and adsorbents including additional layers of other adsorbents, and/or multiple alternating layers of the nitrogen-adsorbing fiber adsorbent and/or the argon-adsorbing fiber adsorbent, are contemplated as being within the scope of the present disclosure. Further, it will be appreciated that instead of the adsorbent being provided as separate and discrete beds of the respective nitrogen-adsorbing fiber adsorbent and the argon-adsorbing fiber adsorbent, in which separate beds of carrier fibers are impregnated with the respective adsorbents, the adsorbent may be formed or constituted as a single bundle of fibers, in which a first length portion of the fibers in the bundle is impregnated, doped, or coated with a first one of the respective nitrogen-adsorbing fiber adsorbent and the argon-adsorbing fiber adsorbent, and in which a second length portion of the fibers in the bundle is impregnated, doped, or coated with the other one of the respective nitrogen-adsorbing fiber adsorbent and the argon-adsorbing fiber adsorbent.

In the implementations of the present disclosure in which the argon-adsorbing fiber adsorbent is a carbon molecular sieve (CMS) fiber adsorbent that is formed using cellulose as a starting material, the CMS fiber adsorbent exhibits a surprisingly and unexpectedly higher equilibrium argon adsorption capacity than that of both oxygen and nitrogen, which is in direct contrast with conventional carbon molecular sieve materials which utilize the faster O₂ mass transfer rate to effect kinetic separation of O₂ and argon. The CMS fiber adsorbent of the present disclosure facilitates a dramatically improved equilibrium adsorption process for high purity oxygen production when utilized in a multilayer fiber adsorbent arrangement in combination with a high-efficiency nitrogen-selective fiber adsorbent such as LiX fiber adsorbent. In such application, the CMS fiber adsorbent provides inexpensive and surprisingly superior argon-versus-oxygen adsorptive selectivity. Further, the cellulosic CMS fiber adsorbent, in addition to being efficient and cost-effective in character, is produced from renewable resource cellulose.

The cellulose-based CMS fiber adsorbent is readily formed by pyrolysis of the cellulose fibers produced by spinning or other fiber-forming process. The cellulose fibers may be readily aggregated in a roving that is then pyrolyzed, or the cellulose fibers may be pyrolyzed prior to aggregation to form a bundle of parallelly aligned fibers whose porosity and interstices formed between adjacent fibers provide flow channels that facilitate contacting of the feed gas to effect argon removal therefrom. Although the CMS fiber adsorbent is primarily described herein as being overlying or downstream in relation to the nitrogen-removing adsorbent, and is desirably in such arrangement so that the CMS fiber adsorbent is contacted with nitrogen-depleted feed gas after the feed gas is contacted with the nitrogen-removing adsorbent, the disclosure is not limited thereto, and the disclosure contemplates arrangements in which the CMS fiber adsorbent may be located upstream or preceding the nitrogen-removing adsorbent, or in which the CMS fiber adsorbent may otherwise be mixed, aggregated, or arranged with the nitrogen-removing adsorbent, for production of high purity oxygen.

FIG. 9 is a schematic representation of a two-bed PSA system for high purity O₂ production according to one embodiment of the present disclosure, including a multi-layer LiX-CMS fiber structured adsorbent for adsorption of nitrogen and argon, in each of the two adsorber vessels. The nitrogen-adsorbing LiX fiber adsorbent in each vessel is in a bottom or base layer of the structured adsorbent, and the argon-adsorbing CMS fiber adsorbent is in a top layer of the structured adsorbent.

As illustrated, the adsorber vessels in the PSA system of FIG. 9 are coupled at their respective inlet ends to a valved inlet manifold, and at their respective output ends, the adsorber vessels are coupled to a valved outlet manifold. Ambient air, or air that has been conditioned with respect to one or more of its humidity, temperature, and pressure, is delivered by the blower to the inlet manifold, in which the various flow control valves in the manifold are operated in appropriate open or closed positions in order to direct the feed air to one of the two adsorber vessels, as an on-stream adsorber vessel.

Concurrently, the other adsorber vessel is undergoing regeneration by the vacuum pump, to desorb previously adsorbed nitrogen and argon from the adsorbent, for flow through the inlet manifold line in which the flow control valve is open for discharge by the vacuum pump of the nitrogen/argon desorbate to the ambient environment or to other disposition or use, or if regeneration has been completed, such other adsorber vessel is in standby mode awaiting the switching of valves in the inlet manifold, to direct the feed air to the previously regenerated adsorber vessel, while the previously on-stream adsorber vessel then undergoes regeneration in the same manner.

In the valved outlet manifold, the flow control valves are likewise operated in appropriate open or closed positions, to enable flow of high purity oxygen from which nitrogen and argon have been adsorbed in the processing of the feed air, from the onstream adsorber vessel to the high purity oxygen collection vessel that is coupled to the outlet manifold for such purpose. Concurrently, the flow control valves in the outlet manifold are closed to the offstream adsorber vessel, so that the offstream vessel can accommodate vacuum desorption and regeneration as above described, and upon completion of regeneration can be switched to onstream operation, or maintained in standby mode awaiting the switching of valves to enable the offstream vessel to resume feed air processing when the adsorbent in the other adsorber vessel has become loaded to a predetermined extent at which onstream processing is terminated and the sorbate-loaded adsorbent is regenerated by the vacuum desorption operation.

In this manner, each of the adsorber vessels cyclically, alternatingly, and repetitively undergoes a sequence of onstream high purity oxygen production operation and an offstream regeneration operation, in the continuous operation of the system. For such purpose, a controller (not shown in FIG. 9) may for example be constructed and arranged to operate valves of the valved flow circuitry in response to at least one of (A) a monitored system operating condition, and (B) a cycle time program, so that each one of the multiple adsorber vessels containing the fiber adsorbent cyclically, alternatingly and repetitively undergoes a sequence of (i) onstream high purity oxygen generation operation and (ii) offstream regeneration operation, in continuous operation of the system.

Although the PSA system shown in FIG. 9 is depicted as a two-adsorber vessel system, it will be appreciated that the disclosure is not limited thereto, and that PSA systems incorporating fiber adsorbent in accordance with the present disclosure may be constituted with three or more adsorber vessels arranged for cyclic operation.

Alternatively, the fiber adsorbent of the present disclosure may be incorporated in a single adsorber vessel system that is likewise arranged for cyclic operation including adsorption operation to generate high purity oxygen and subsequent regeneration of the adsorbent in the adsorber vessel to renew the adsorbent in such adsorber vessel for renewed adsorption operation.

In preferred practice, the PSA system is constituted as including two or more adsorber vessels, to carry out continuous high purity oxygen generation operation.

Thus, a simple 2-layer PSA process arrangement as depicted in FIG. 9 enables N₂ and Ar to be adsorptively removed from the feed air to yield high purity O₂. Further, since the material cost of the CMS fiber adsorbent is substantially cheaper than Ag-based zeolite, while possessing even higher Ar/O₂ selectivity (e.g., up to 1.6) as compared to Ag-zeolite (1.2), it follows that the deployment of the CMS fiber adsorbent in the PSA oxygen generation system will provide a significant cost advantage in relation to the nitrogen-adsorption and argon-adsorption systems of the prior art. Moreover, adsorbent fiber-based PSA beds of the present disclosure have lower bed size factor and exhibit a higher mass transfer coefficient, as compared to conventional sorbent bead adsorbent PSA systems. The adsorbent fibers utilized in accordance with present disclosure provide a reduced pressure drop in the PSA adsorber vessel, as well as eliminating attrition and dusting problems that accompany the use of conventional bead adsorbents. Further, the CMS adsorbent fibers do not require high temperature activation.

In the dual-layer rapid cycle PSA system using LiX and CMS fiber adsorbents as shown in FIG. 9, the adsorbent bed configuration can in further embodiments be modified so that a third LiX layer is added over the CMS fiber adsorbent layer, or the first LiX fiber adsorbent layer can be increased in size, for further nitrogen content reduction to produce even higher purity oxygen if desired.

The PSA process of the present disclosure, utilizing LiX and CMS fiber adsorbents, can achieve oxygen production costs of less than $50/ton of high purity oxygen, representing a major cost-competitive advantage and advance in the oxygen production industry.

The multi-layer structured adsorbent modules of the present disclosure enable a simple drop-in retrofit capability for high purity oxygen production in existing PSA systems. The fiber structured module provides a low bed-size-factor and pressure drop. In retrofit applications to existing PSA or VPSA systems, the multi-layer structured adsorbent modules of the present disclosure enable higher productivity to be achieved with the same blower and vacuum pump equipment, flow circuitry, and adsorber vessels utilized in the PSA installation prior to the retrofit, resulting in overall lower unit O₂ production cost.

Accordingly, while the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1. A structured adsorbent assembly, comprising an array of generally parallelly aligned cellulose pyrolyzate carbon fibers that are sorptively selective for argon when contacted with an oxygen and argon gas mixture, wherein the generally parallelly aligned cellulose pyrolyzate carbon fibers are sized and arranged to provide interstitial gas flow passages between adjacent generally parallelly aligned fibers of the array for flow of gas therethrough.

2. The structured adsorbent assembly of claim 1, wherein the cellulose pyrolyzate carbon fibers are spun fibers and the cellulose comprises microcrystalline cellulose.

3. The structured adsorbent assembly of claim 1, wherein the cellulose pyrolyzate carbon fibers have a diameter in a range of from 200 μm to 800 μm.

4. The structured adsorbent assembly of claim 1, wherein the array of generally parallelly aligned cellulose pyrolyzate carbon fibers constitutes a first portion of the structured adsorbent module, and the structured adsorbent assembly includes at least a second adsorbent portion comprising a nitrogen-selective adsorbent.

5. The structured adsorbent assembly of claim 4, wherein the nitrogen-selective adsorbent comprises LiX zeolite.

6. The structured adsorbent assembly of claim 5, wherein the LiX zeolite is contained on and/or in polymeric fibers.

7. The structured adsorbent assembly of claim 6, wherein the polymeric fibers comprise polyimide fibers.

8. The structured adsorbent assembly of claim 6, wherein the polymeric fibers have a diameter in a range of from 200 μm to 800 μm.

9. The structured adsorbent assembly of claim 6, wherein the polymeric fibers are generally parallelly aligned with one another in an array thereof, wherein the generally parallelly aligned polymeric fibers are sized and arranged to provide interstitial gas flow passages between adjacent generally parallelly aligned polymeric fibers of the array for flow of gas therethrough.

10. The structured adsorbent assembly of claim 8, wherein the interstitial gas flow passages in the second adsorbent portion of the structured adsorbent assembly are generally aligned with the interstitial gas flow passages in the first adsorbent portion of the structured adsorbent assembly, so as to accommodate serial gas flow through the first and second adsorbent portions of the structured adsorbent assembly.

11. A structured adsorbent assembly, comprising
(i) LiX zeolite contained on and/or in first polymeric fibers; and
(ii) one selected from the group consisting of (a) AgX zeolite contained on and/or in second polymeric fibers, and (b) cellulosic carbon molecular sieve fibers.

12. The structured adsorbent assembly of claim 11, comprising AgX zeolite contained on and/or in second polymeric fibers.

13. The structured adsorbent assembly of claim 11, comprising cellulosic carbon molecular sieve fibers.

14. The structured adsorbent assembly of claim 11, in which the first polymeric fibers and second polymeric fibers comprise polyimide fibers.

15. A structured adsorbent assembly, comprising
(i) a nitrogen-selective adsorbent; and
(ii) one selected from the group consisting of (a) AgX zeolite contained on and/or in polymeric fibers, and (b) cellulosic carbon molecular sieve fibers.

16. The structured adsorbent assembly of claim 15, comprising AgX zeolite contained on and/or in polymeric fibers.

17. The structured adsorbent assembly of claim 16, wherein the polymeric fibers comprise polyimide fibers.

18. The structured adsorbent assembly of claim 15, comprising cellulosic carbon molecular sieve fibers.

19. The structured adsorbent assembly of claim 15, wherein fibers therein are comprised in fiber bundles through which gas containing components sorbable by adsorbents of the structured adsorbent assembly are flowable.

20. A pressure swing adsorption (PSA) system comprising at least one adsorber vessel containing the structured adsorbent assembly of claim 1.

21. The PSA system according to claim 20, comprising at least two adsorber vessels each containing the structured adsorbent assembly.

22. The PSA system according to claim 20, comprising multiple adsorber vessels each containing the structured adsorbent assembly, wherein the multiple adsorber vessels are constructed and arranged so that each of the multiple adsorber vessels cyclically, alternatingly, and repetitively undergoes a sequence of onstream high purity oxygen production operation and an offstream regeneration operation, in operation of the PSA system.

23. The PSA system according to claim 22, constructed and arranged for vacuum PSA operation.

24. A pressure swing adsorption (PSA) process for production of high purity oxygen, the process comprising:
contacting gas containing oxygen, nitrogen, and argon with a first adsorbent selective for nitrogen to at least partially adsorb nitrogen from the gas to yield nitrogen-depleted gas;
contacting the nitrogen-depleted gas with a second adsorbent selective for argon to at least partially adsorb argon from the gas to yield high purity oxygen; and
recovering the high purity oxygen,
wherein the first adsorbent and the second adsorbent when loaded to a predetermined extent with sorbate are regenerated by pressure swing desorption of sorbate therefrom, to renew the first adsorbent and the second adsorbent for renewed contacting in the PSA process.

25. The PSA process of claim 24, wherein the first adsorbent and the second adsorbent are comprised in a structured adsorbent assembly as claimed in claim 1.
